(19) United States
(12) Patent Application Publication
(10) Pub. No.: US 2002/0188402 A1
(43) Pub. Date: Dec. 12, 2002

(54) Search oriented geographic information system

(75) Inventors: Yu-Wen Huang, KaoShiung (TW); Ching-Feng Wang, TaiNan (TW)

Correspondence Address: DOUGHERTY & TROXELL, 5205 LEESBURG PIKE, SUITE 1404, FALLS CHURCH, VA, 22041, US

(73) Assignee: TelePaq Technology Inc.

(21) Appl. No.: 09/874,107

(22) Filed: Jun. 6, 2001

(51) Int. Cl. G01C 21/00

(52) U.S. Cl. 701/213; 342/357.06

(57) ABSTRACT

A search oriented geographic information system (GIS) includes a hand held input display process unit which couples with a global position system (GPS) for displaying road map menu on a display screen for user selection and use. A global system for mobile communication (GSM) is used to transmit vehicle location coordinates data and user selection item through the GSM base stations to a GIS server which processes the receiving data and produces output results for transmitting back to the input display process unit through the GSM for user to get the most updated road and street map information around the vehicle.

### 1. FIELD OF THE INVENTION

This invention relates to a search oriented Geographic Information System (hereinafter called GIS) that employs an input display process unit linking with a Global Position System (hereinafter called GPS) for displaying selected street and geographic information around a vehicle on the input display process unit.

### 2. BACKGROUND OF THE INVENTION

Motor vehicle is a popular and essential transportation means for many people in their lives for work and pleasure activities such as travelling. Road map is a basic tool many motorists have to prepare and refer to in their driving. The printed road map usually is difficult to use during driving. A journey could easily cover several pages of road map. It is risky and accident prone when trying to find correct travel route by turning map pages during driving because of driver's distraction. A large single page road map usually folds in several sections which is cumbersome to unfold and use. The printed map and characters could be very small and not easy to read. The update cycle of printed map usually is not very timely and map information could be easily out of date and misleading. Technology innovations in recent years, particularly in electronic and communication, have provided improved techniques to resolve this problem, GPS is one of the examples. FIG. 1 illustrates the general process flow of the GPS. There are communication satellites 10 travelling around in the earth orbits and constantly beaming GPS signals 11 earth bound. The GPS signals may be picked up by vehicles which have installed GPS-enabled car or notebook computer 12. The GPS signals which in general identify geographic location coordinates of the vehicle may become a completed road map by combining with road and street information retrieved from the data base stored in optical disk storage 14 resided in the remote servers and transmitted through modems and the Internet 13 to the computer in the car. The completed road map may be displayed on a display unit in the car computer constantly and readily to indicate vehicle location and destination and the optimum route or alternative routes available. As the road map data base stored in the optical disk storage may be updated timely, drivers may always get the most accurate and up to date road map in the car computer. Hence this GPS-based road map technology has increasingly gained popularity in auto industry.

However the GPS-based road map is still far from perfect. One of the problems is that the update of map data base stored in optical disk still does not reach the desired level. Many out of date data are still existed and are misleading. Another problem results from limited display size of computers equipped in the vehicles. Because of space constraint inside the vehicle driving compartment, most GPS-based road map technologies now use car computer, notebook computer or even Personal Digital Assistant (PDA). They all have relatively small display screens and cannot contain too much and too detailed detail information, otherwise the map information will become too crowd and not illegible when shown in the display units. Hence however to weed out not accurate and essential data from the road map data base, and to make data base update more timely and enable only essential and useful information be retrieved and transmitted and displayed in the car computers is a hot research topic in recent years.

### SUMMARY OF THE INVENTION

It is an object of this invention to provide a search oriented geographic information system that simplifies voluminous road map data base to essential and accurate geographic information to be used in an input display process unit in vehicles.

In one aspect, this invention includes a PDA which has GPS capability or communication interface and may also communicate with a GIS server for transmitting desirable and accurate road map data to the input display process unit in the vehicle.

In another aspect, the input display process unit of this invention may receive a wireless data catalog which contains service item menu for user selection. This function may further coupled with the Wireless Application Protocol (WAP) of Global System for Mobile communications (GSM) to enhance the application and versatility of this invention.

In still another aspect, this invention may have a server end and a user end (i.e. the PDA). The GIS server periodically updates GIS data base and catalog, and transmits through the server end to the user end for user use.

In yet another aspect, input data are received, processed and integrated through GPS and GIS server end coordinates, then trigger GSM base station for transmitting to user end at the vehicle.

In a further aspect, user end receives selection menu signals, systems service provider may send service selection menu to the input display process unit for displaying. User may select service item from the menu and initiate commands for data communication and authorization.

In still another aspect, user selected GIS items may be transmitted backed to the systems service provider through communication interface, then forwarded to the GIS server for process desired, such as data base update. Updated data base may be transmitted back to the user end.

### BRIEF DESCRIPTION OF THE DRAWINGS

The invention, as well as its many advantages, may be further understood by the following detailed description and drawings, in which:

FIG. 1 is a process flow chart of a conventional search oriented geographic information system.

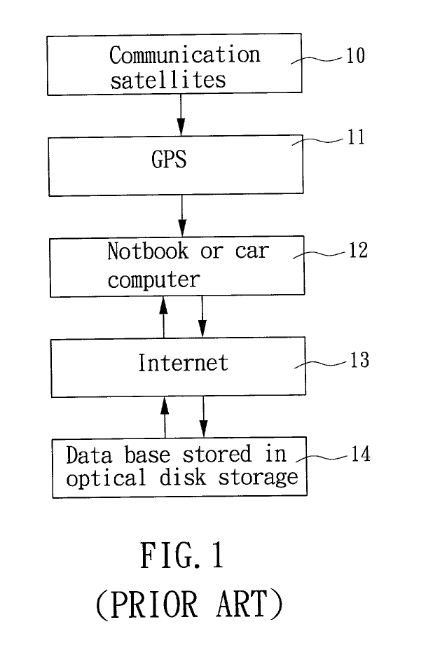

FIG. 2 is a process flow chart of this invention.

FIG. 3 is a front view of an input display process unit for this invention, using the personal digital assistant (PDA).

### DETAILED DESCRIPTION OF THE PREFERRED EMBODIMENT

This invention aims at providing a search oriented geographic information system (GIS) that uses a selected input display process unit such as a PDA to couple with a GPS for actively recognizing user's identification and location coordinates to transmit GIS service selection menu through a network system service provider to the PDA for display. By employing broadcasting communication technique of one-to-many communication protocol, the service selection menu may be sent to many receiver ends actively for saving duplex transmission bandwidth resources.

Within the architecture of this invention, users select the GIS service item. The selection is transmitted through a communication interface to the system service provider, then forwarded to a GIS server for process. There is a GIS data base being periodically updated and has process to produce a kernel geographic information (containing only essential and useful data, but removing unnecessary and secondary data like nonessential buildings, gas stations, tourist spots, etc.). The kernel information may be better fitted in the smaller memory and display like PDA and may be transmitted through the communication interface to the user end at the input display process unit for display and use by the user.

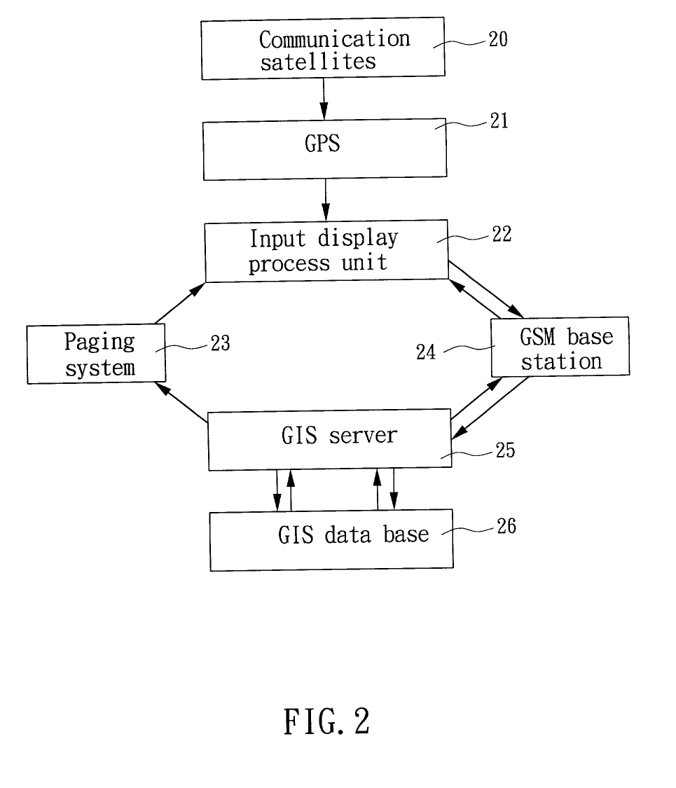

When put in practice, this invention uses the modern Wireless Application Protocol (WAP) in mobile phone technology for carrying a large amount of electronic data to a multifunctional PDA at user end. FIG. 2 illustrates the process flow of this invention. The input display process unit 22 is located in a vehicle and may be a notebook computer, car computer or a PDA. The vehicle further has installed a GPS 21. When a user enters a command on the input display process unit for searching a map (such street or road map) around the vehicle, the command will be transmitted through the GPS 21 to a communication satellite 20 for getting the coordinates of the vehicle location. Then a GSM base station 24 will be activated for feeding the coordinates data and search command to a GIS server 25 which fetches needed data from a GIS data base 26 to process with the coordinates data. The result is a completed road map with vehicle location which will be transmitted through the GIS server 25 and GSM base station 24 back to the input display process unit 22 for display. User thus may see accurate road or street map around the vehicle readily from the display screen. Besides the GSM base station, other wireless duplex communication systems may also be used.

In addition to providing accurate and updated map information for vehicle drivers, this invention may also provide map update function. It is done by scanning input or software abstracting updated data to feed in the GIS data base 26 and processed by the GIS server 25. The GIS server 25 may transmit the updated data through a paging system 23 to the input display process unit 22 at the user end. The GIS server 25 may also receive updated data from the GSM base station 24 and transmits the updated data to the user end (i.e. input display process unit 22) through the GSM base station 24.

For this invention to function as desired, the input display process unit must couple with the GPS system for getting vehicle location coordinates to the GIS server for process. When using a PDA as the input display process unit, the PDA should include a GPS circuit and becomes multifunctional. The GPS circuit may also be an independent member with an interface for connecting with the interface slot of the PDA.

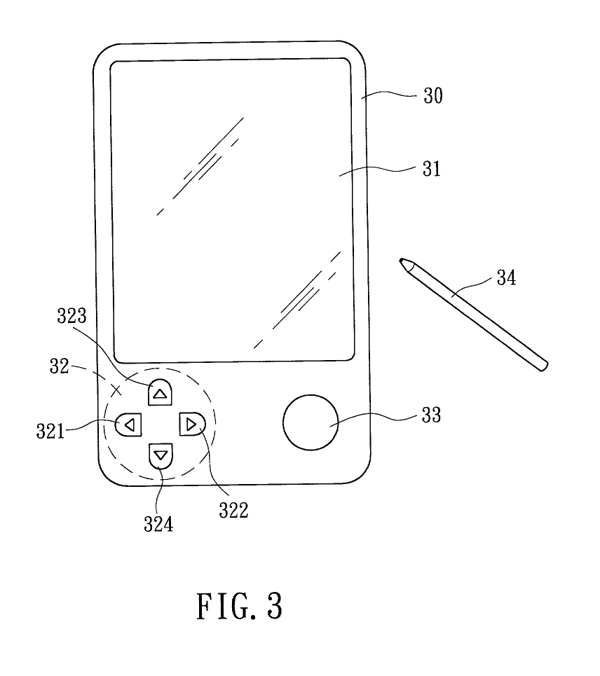

FIG. 3 shows a pictorial view of a PDA 30 served as an input display process unit in this invention. It has a display screen 31 for display service selection menu. Below the display screen 31, there are a selection unit 32 and an enter button 33. The selection unit 32 includes a left direction key 321, a right direction key 322, an upward key 323 and a downward key 324 for moving the cursor to a selected item in the menu shown on the display screen 31. The enter button 33 is to activate the selected process. The PDA may also equip a sensing pen 34 for touching the display screen 31 to make selection desired.

It may thus be seen that the objects of the present invention set forth herein, as well as those made apparent from the foregoing description, are efficiently attained. While the preferred embodiment of the invention has been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A search oriented geographic information system, comprising,
a communication satellite for detecting and indicating location coordinates of a vehicle on earth,
a global position system located in the vehicle for emitting signals and receiving vehicle location coordinates signals from the communication satellite,
an input display process unit located in the vehicle for receiving inquiry input commands for the vehicle location from a user and displaying searched output on a display screen thereof,
a paging system serving as an one way data transmission system for transmitting data from a system server to the display screen,
a global system for mobile communications base station serving as a two ways data transmission system for transmitting data between the system server and input display process unit including sending the vehicle location coordinates data and inquiry input commands to the system server, and transmitting inquiry results to the input display process unit,
a geographic information system server for receiving the inquiry input commands and vehicle location coordinates data, retrieving geographic data from the system server, processing the receiving and retrieving data, and sending the inquiry results to the paging system and global system for mobile communications base station, and
a geographic information system data base for storing geographic data desired including updated data base information.

2. The search oriented geographic information system of claim 1, wherein the input display process unit is selected fi-om the group of notebook computer, car computer and personal digital assistant.

3. The search oriented geographic information system of claim 2, wherein the personal digital assistant includes:
a display screen for displaying an information menu,
a direction selection unit having a left direction key, a right direction key, an upward key and a downward key for controlling cursor moving direction,
an enter button for executing selected commands, and
a sensing pen for touching the display screen to select an object and initiate execution of a corresponding work related to the object.

4. The search oriented geographic information system of claim 2, wherein the personal digital assistant includes a global position system circuit and is multifunctional.

5. The search oriented geographic information system of claim 1, wherein the global position system is made in an independent circuit having an external interface engageable with an interface slot in a personal digital assistant for combining the global position system function in the personal digital assistant.

6. The search oriented geographic information system of claim 3 or 4, wherein the global position system may actively identify the vehicle location coordinates and transmitting location coordinates data to the geographic information system server through a communication interface.

7. The search oriented geographic information system of claim 1, wherein the data transmission system employs Wireless Application Protocol used in mobile phone communication systems.

8. The search oriented geographic information system of claim 1, wherein the geographic information system data base is retrieved and updated through scanning input or a software program.

9. The search oriented geographic information system of claim 1, wherein the geographic information system data base is updated through the paging system in one way manner.

10. The search oriented geographic information system of claim 1, wherein the geographic information system data base is updated through the global system for mobile communications base station.
